(19) United States
(12) Patent Application Publication
(10) Pub. No.: US 2015/0002025 A1
(43) Pub. Date: Jan. 1, 2015

(54) LIGHTING ASSEMBLY, APPARATUS AND ASSOCIATED METHOD FOR MAINTAINING LIGHT INTENSITIES

(71) Applicant: General Electric Company, Schenectady, NY (US)

(72) Inventors: Danijel Maricic, Niskayuna, NY (US); Ramanujam Ramabhadran, Niskayuna, NY (US); John Thomas Garrity, Ballston Spa, NY (US)

(21) Appl. No.: 13/931,272

(22) Filed: Jun. 28, 2013

(51) Int. Cl. H05B 33/08

(52) U.S. Cl. CPC H05B 33/0851
USPC 315/151

(57) ABSTRACT

In accordance with one embodiment, a lighting assembly is provided. The lighting assembly includes a first light unit configured to operate at a first duty cycle and a second light unit configured to operate at a second duty cycle. The second duty cycle is less than the first duty cycle, and the first and second light units emit light having a same wavelength.

### BACKGROUND

The invention relates generally to lighting assemblies, lighting apparatuses and associated methods and, more particularly, to lighting assemblies, apparatuses and methods for maintaining light intensities of light units.

Light units or light sources are solid-state semiconductor devices such as light emitting diodes (LEDs), organic LEDs (OLEDs), fluorescent lights, incandescent lamps, or the like. Recent advances in lighting technology have provided efficient and robust light sources that enable a variety of lighting effects in many applications. Some lighting fixtures may include one or more light sources capable of producing different colors, for example, red, green, and blue (RGB), and a controller for controlling an output light of the light sources in order to generate a variety of colors and color-changing lighting effects.

Aspects of the output light, such as chromaticity, are dependent on, for example, intensity output of the light sources. The intensity output may fluctuate even when a driving current of a light source is constant, due to factors such as changes in ambient temperature, aging of the light source or any combination thereof.

One existing approach to compensate or avoid these issues is to employ an optical feedback mechanism to continuously monitor light intensity output (or flux output) from different color light sources so as to adjust the driving currents of the light sources such that the light intensity output (or luminous flux) of the output light remains substantially constant. The monitoring may be done using a plurality of photo-sensors, each of which may monitor the light intensity output of each color (of the light source) in order to provide for correction if this output deviates from a desired reference light intensity value (‘reference value’). In another approach, the monitoring may be done using a single photo-sensor. The monitored intensity output may be then fed to a controller that adjusts the driving current of the light source accordingly, thereby controlling the color of the light emitted from each light source at the reference value.

The existing approach may result in erroneous value of the light intensity output when a sensing chain including a sensor (such as a photo-sensor), an analog-to-digital converter, or an amplifier in a lighting assembly deteriorates (for example, ages) or gain of the sensing chain changes. In other words, the existing approach does not consider (or compensate for) aging of the sensing chain or gain change of the sensing chain when comparing the sensor output with the reference light intensity value, thereby resulting in erroneous value of the light intensity output. When the reference light intensity value is recorded earlier, the intensity output monitored at a sensor may output a value that is different from this reference value (that is due to aging of the sensing chain or gain change of the sensing chain) even though there is no aging of the light source. In the existing approach, the controller may adjust the driving current, and hence the intensity output, even though the change in the monitored intensity output was not due to aging of the light source. For example, in the existing approach, in case of a lighting fixture that includes light sources of different colors, if the reference light intensity value is 10 and the intensity output of a light source is set at 10 initially, after one year the intensity output monitored at a sensor may change to 8 due to aging of the sensing chain or gain change of the sensing chain. In this example, the controller may assume that the change in the intensity output is due to aging of light source and may increase the driving current to set the intensity output to the initially recorded reference value (that is, 10) and thus resulting in undesired color point shift.

Hence, there is a need for a lighting assembly, a lighting apparatus and an associated method to accurately determine an intensity output of a light source. Moreover, there is a need to differentiate between light source deterioration and sensing chain deterioration.

### BRIEF DESCRIPTION

In accordance with one embodiment, a lighting assembly is provided. The lighting assembly includes a first light unit configured to operate at a first duty cycle and a second light unit configured to operate at a second duty cycle. The second duty cycle is less than the first duty cycle, and the first and second light units emit light having a same wavelength.

In accordance with another embodiment, a lighting apparatus is provided. The lighting assembly includes a lighting assembly comprising a first light unit configured to operate at a first duty cycle and a second light unit configured to operate at a second duty cycle. The second duty cycle is less than the first duty cycle, and the first and second light units emit light having a same wavelength. The lighting apparatus further includes a current driver unit electrically coupled to the first and second light units and configured to provide driving currents to the first and second light units. The lighting apparatus further includes a sensor unit optically coupled to the first and second light units and configured to sense light emitted from the first light unit and light emitted from the second light unit so as to determine corresponding first and second intensity values. The lighting apparatus further includes a controller unit communicatively coupled to the sensor unit and the current driver unit, and configured to receive the first and second intensity values from the sensor unit and determine magnitudes of the driving current provided by the current driver unit to the first and second light units based on the received first and second intensity values.

In accordance with another embodiment, a method for maintaining light intensities of operating light sources is provided. The method includes receiving a first intensity value corresponding to a first light unit and a second intensity value corresponding to a second light unit at a controller unit. The first light unit operates at a first duty cycle and the second light unit operates at a second duty cycle such that the second duty cycle is less than the first duty cycle, and the first and second light units emit light having a same wavelength. The method further includes determining by the controller unit, magnitudes of driving current provided to the first and second light units based on the received first and second intensity values.

### DRAWINGS

These and other features and aspects of embodiments of the present invention will become better understood when the following detailed description is read with reference to the accompanying drawings in which like characters represent like parts throughout the drawings, wherein:

FIG. 1 is an electrical schematic diagram of a lighting apparatus, in accordance with one embodiment.

FIG. 2 represents the lighting apparatus including a current driver unit corresponding to each light source in order to drive these light sources, in accordance with one embodiment.

FIG. 3 represents the lighting apparatus including a single current driver that is used to drive operating and corresponding reference light sources of same wavelength, in accordance with another embodiment.

FIG. 4 illustrates a lighting assembly including the operating and corresponding reference light sources disposed on a same heat sink, in accordance with one embodiment.

FIG. 5 illustrates the lighting assembly including the operating light source disposed on a first heat sink and the corresponding reference light source disposed on a second heat sink, in accordance with another embodiment.

FIG. 6 illustrates the lighting assembly including a thermal relay disposed between the operating and corresponding reference light sources and configured to thermally couple or decouple the reference light source disposed on the second heat sink from the operating light source disposed on the first heat sink, in accordance with yet another embodiment.

FIG. 7 illustrates schematically timing charts of duty cycles of respective light sources in a blue-shifted YAG (BSY), that is white colored, and red lighting assembly for sensing light emitted by light sources using time-division multiplexing (TDM), in accordance with one embodiment.

FIG. 8 illustrates schematically timing charts of duty cycles of the respective light sources in the BSY+R lighting assembly for sensing light emitted by the light sources using TDM, in accordance with another embodiment.

FIG. 9 is a flowchart depicting a method for maintaining light intensities of operating light sources, in accordance with one embodiment.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of terms such as “including,” “comprising,” or “having” and variations thereof herein are meant to encompass the items listed thereafter and equivalents thereof as well as additional items. Additionally, for purposes of explanation, specific numbers, components, and configurations are set forth in order to provide a thorough understanding of various embodiments of the invention.

Embodiments of the invention are directed to a lighting assembly, a lighting apparatus and an associated method to accurately determine an intensity output of a light unit or a light source. Moreover, the embodiments of the invention differentiate between deterioration of the light source and deterioration of a sensing chain, which is a component of the lighting apparatus. The lighting assembly may include a first light unit configured to operate at a first duty cycle and a second light unit configured to operate at a second duty cycle. In various embodiments, the second duty cycle is less than the first duty cycle, and the first and second light units may emit light having a same wavelength. Various embodiments of the invention described herein primarily relate to maintaining light intensities of light emitting diodes (LEDs) as the light sources; however, the invention may be extended to other types light sources such as, but not limited to, organic LEDs (OLEDs), fluorescent lights, or incandescent lamps without deviating from the scope of the invention.

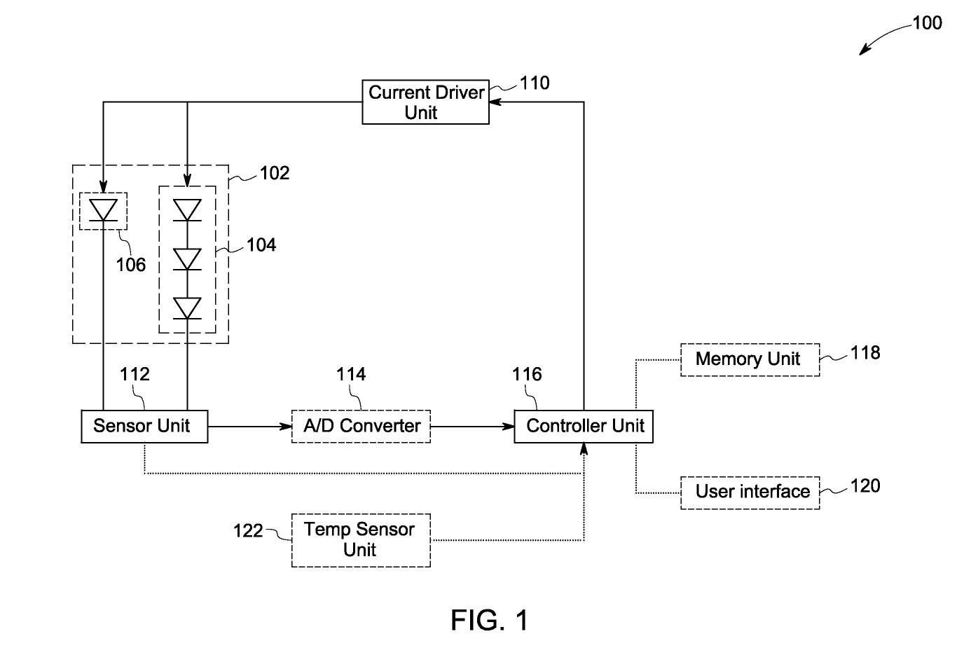

FIG. 1 is an electrical schematic diagram of a lighting apparatus 100 (hereinafter ‘apparatus 100’), in accordance with one embodiment. As shown in FIG. 1, in some embodiments, the apparatus 100 may include a lighting assembly 102. As shown in FIG. 1, in one embodiment, the lighting assembly 102 may include an operating light source 104 (“first light unit”) operating at a first duty cycle and a reference light source 106 (“second light unit”) operating at a second duty cycle. The term ‘operating light source’ as used herein refers to any light source that is used for lighting an environment such as a room, a building, or the like. On the other hand, the term ‘reference light source’ as used herein refers to any light source that is used as a reference device having lighting characteristic similar to that of the operating lighting source (except for the difference in the duty cycles) and this reference device may not be used for lighting the environment.

The term ‘duty cycle’ herein refers to the total amount of time a pulse is ON over the duration of a cycle. For example, for the cycle duration of 20,000 microseconds (or 50 Hz), a 50% duty cycle requires the pulse to be ON for 10,000 microseconds and then OFF for the same amount of time. In various embodiments, the second duty cycle is less than the first duty cycle. In other words, the ON time of the reference light source 106 is less than the ON time of the operating light source 104. For example, over a lifetime of the operating light source 104, if the total ON time of the operating light source 104 is 50,000 hours, then the total ON time of the corresponding reference light source 106 during same time period may be configured to be as low as 50 to 100 hours. Light source aging is mainly dependent on the duration for which the light source is driven or kept ON. Lowering the duty cycle of the reference light source 106 results in driving the reference light source 106 for a small duration in comparison to the operating light source 104. Small duration facilitates reduced aging of the reference light source 106, with the result that the reference light source 106 is used as a reliable reference to check for the light intensity deterioration of the corresponding operating light source 104.

Alternatively, in another embodiment, the lighting assembly 102 may include a plurality of operating light sources (shown as dashed box in FIG. 1) of same wavelength. In this embodiment, the lighting assembly includes a single reference light source (such as 106) corresponding to these operating light sources that operate at the second duty cycle, while the operating light sources are operating at the first duty cycle, which is greater than the second duty cycle.

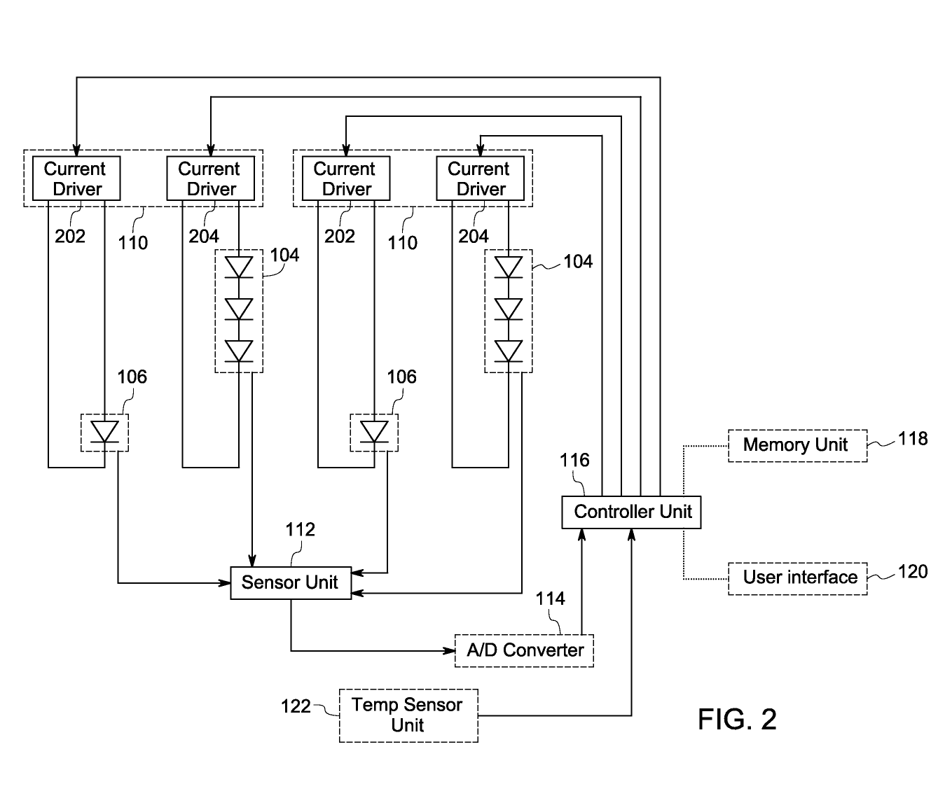

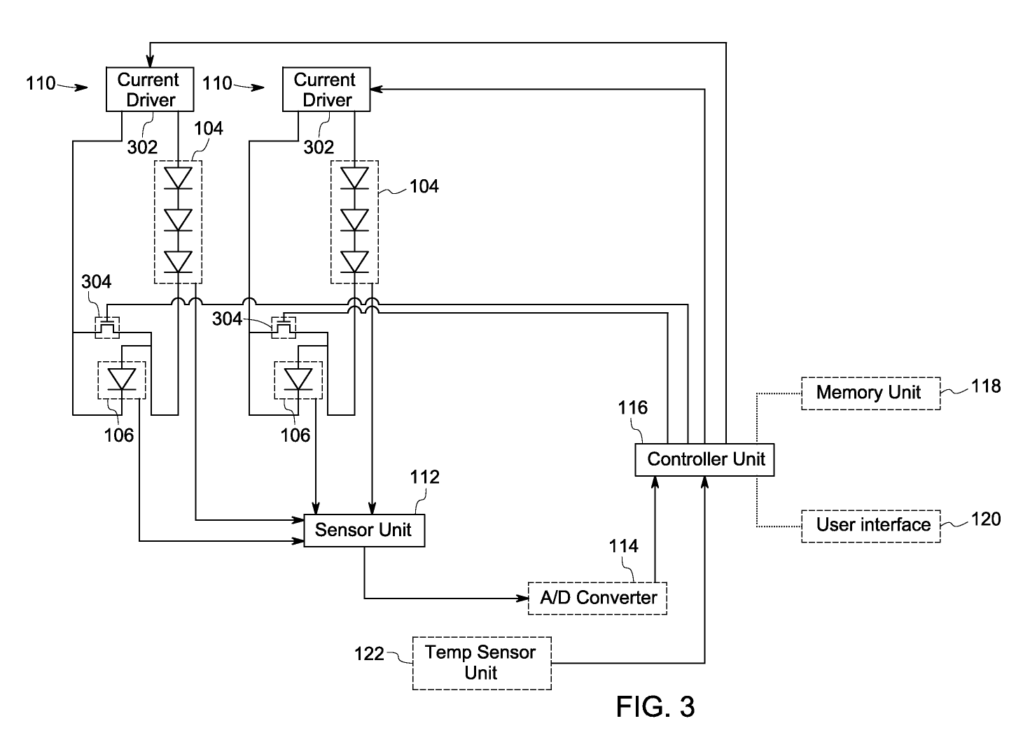

In various embodiments, the operating light source 104 (or the plurality of operating light sources) and the reference light source 106 emit light having a same wavelength or color. For example, both the operating light source 104 and the reference light source 106 may emit light of a same wavelength such as red, blue, or green. Even though FIG. 1 depicts one lighting assembly 102 including one or more operating light sources and one reference light source corresponding to the operating light source(s) of same color, the invention may be extended to any number of similar lighting assemblies each of which may include one or more operating light sources and one reference light source corresponding to these operating light sources such that each lighting assembly emits light of different wavelength or color. This aspect is shown and described later in conjunction with FIGS. 2 and 3.

The apparatus 100 may further include a current driver unit 110 that is electrically coupled to the operating and reference light sources 104 and 106. The current driver unit 110 is configured to provide driving currents to the operating and reference light sources 104 and 106. Although not shown in FIG. 1, the current driver unit 110 may include a plurality of current drivers such that each current driver provides driving current to respective light source. For example, the current driver unit 110 includes a first current driver (not shown) to provide driving current to the operating light source 104 and a second current driver (not shown) to provide driving current to the reference light source 106. The current drivers may be current regulators, switches or other similar devices as will be known to those skilled in the art. In one embodiment, the current driver unit 110 drives the operating light source 104 to emit light in the first duty cycle, and the current driver unit 110 drives the reference light source 106 to emit light in the second duty cycle. In various embodiments, the current driver unit 110 is configured to drive the light sources 104 and 106 of same wavelength with driving current of same magnitude. Power required to drive the light sources 104 and 106 may be provided by a power supply (not shown).

The apparatus 100 may further include a sensor unit 112 optically coupled to the operating and reference light sources 104 and 106. The sensor unit 112 is configured to sense light emitted from the light source 104 and light emitted from the light source 106 so as to determine first and second intensity values corresponding to the light sources 104 and 106, respectively, from the emitted lights. In some embodiments, during the first duty cycle, the current driver unit 110 is configured to drive the operating light source 102 to emit light of, for example, red color. In such embodiments, the sensor unit 112 senses the light intensity of the emitted light to determine corresponding first intensity value. In some other embodiments, during the second duty cycle, the reference light source 106 may be driven to emit light of the same color as the operating light source 102. In such embodiments, the sensor unit 112 senses the light intensity of the light emitted from the light source 106 to determine corresponding second intensity value.

In one embodiment, the sensor unit 112 may include a red light sensor, a green light sensor and a blue light sensor configured to detect intensity of the light emitted from the red light sources, the green light sources and the blue light sources, respectively. Alternatively, in another embodiment the sensor unit 112 may include a color filter configured to detect different color portions of a mixed light emitted from the multiple light sources. In such an embodiment, the apparatus 100 may optionally include a light mixing unit (not shown) positioned between lighting assemblies of multiple light sources and the sensor unit 112 for uniformly mixing the light emitted from multiple light sources. In some embodiments, the sensor unit 112 is an optical sensor such as a phototransistor, a photo-sensor integrated circuit (IC), a non-energized LED, a silicon photodiode with an optical filter, or the like. In one embodiment, the sensor unit 112 may include analog sensors. In another embodiment, the sensor unit 112 may include digital sensors.

The apparatus 100 may further include a controller unit 116 communicatively coupled to the sensor unit 112 and the current driver unit 110. The controller unit 116 may optionally include an analog-to-digital (A/D) converter 114. The A/D converter 114 may be either between the sensor unit 112 and the controller unit 116 (as shown in FIG. 1) or integrated with the controller unit 116 or the sensor unit 112. The A/D converter 114 is configured to receive the intensity values (which may be in an analog format) from the sensor unit 112 and convert them to a digital format for the controller unit 116 to process further. In another embodiment, when the sensor unit 112 is a digital sensor, the intensity values determined by the sensor unit 112 may be in a digital format.

The controller unit 116 in the apparatus 100 is configured to receive the first and second intensity values from the sensor unit 112 (or the A/D converter 114) and determines magnitudes of the driving current that is provided by the current driver unit 110 to the light sources 104 and 106 based on these received intensity values. In some embodiments, in order to determine magnitudes of the driving current provided by the current driver unit 110 to the light sources 104 and 106, the controller unit 116 is configured to compare a ratio between the first and second intensity values (“light intensity ratio”) with a ratio between first and second reference intensity values. The first and second reference intensity values are the intensity values of the respective light sources 104 and 106 and are determined (for example, measured or set initially during installation of the apparatus 100) for future reference. In one embodiment, when the two ratios are equal, the magnitudes of the driving current remain unchanged; however, when these two ratios are different, the controller unit 116 may adjust the magnitudes (either of the light source 104 alone or of both the light sources 104 and 106) of the driving current until the two ratios become equal. In various embodiments, adjusting these magnitudes results in controlling light intensity and hence color of the light source 104.

In one exemplary embodiment, when the first and second reference intensity values are 10 and 2, respectively, and the controller unit 116 receives 8 and 2 as the first and second intensity values, respectively, the controller unit 116 compares the ratios 8/2 and 10/2 to determine whether they are equal or not. In this example, difference in the two ratios signifies that the operating light source 104 has deteriorated (for example, due to aging). The controller unit 116 in such a case may therefore adjust the magnitudes of the driving current (to be fed to the light source 104 and optionally to the light source 106) until the two ratios become equal. For example, if the operating light source 104 deteriorates, magnitudes of driving current of the operating light source 104 and, optionally, corresponding reference light source 106 of the same color are reduced.

In another exemplary embodiment, when the first and second reference intensity values are 10 and 2 and the controller unit 116 receives 8 and 1.6 as the first and second intensity values, respectively, the controller unit 116 compares the ratios 8/1.6 and 10/2 to determine whether they are equal or not. In this example, even though the received intensity values are different from the respective reference intensity values, equal ratios signifies that the operating light source 104 is functioning normally (that is, it has not deteriorated). The controller unit 116 in this example may infer that the difference in individual intensity values (in comparison to the respective reference intensity values) is due to some error in a sensing chain, for example, due to change in the gain of the sensing chain. In various embodiments, the sensing chain includes the sensor unit 112, the A/D converter 114, an amplifier (not shown in FIG. 1), or any combination thereof. Since the operating light source 104 is functioning normally, the controller unit 116 keeps the magnitudes of the driving current unchanged. The controller unit 116 is therefore able to differentiate between deterioration of the light source and deterioration of the sensing chain.

In some other embodiments, when the two ratios are different, which signifies that the operating light source 104 has deteriorated, the controller unit 116 may adjust the magnitudes of the driving current (to be fed to the light source 104 and optionally to the light source 106) until the deviation of the ratio between the first and second intensity values from the ratio between the first and second reference intensity values is minimized. For example, the deviation within thirty percent may be allowed.

Maintaining the light intensity ratio between each operating light source (or multiple operating lights sources of same wavelength) and its corresponding reference light source of same wavelength results in maintaining the light intensity ratios among two or more lighting assemblies of different color light sources, where each assembly includes one or more operating light sources and its corresponding reference light source emitting light of same wavelength. In some embodiments, when the controller unit 116 determines that the two ratios are different and hence magnitudes of the driving current fed to the light sources 104 and 106 are to be changed until the two ratios become equal, the controller unit 116 may also change the magnitudes of other lighting assemblies of respective colored light sources to maintain the light intensity ratios among these lighting assemblies. In one exemplary embodiment, if the operating light source 104 of a first color deteriorates, magnitudes of driving current of the operating light source 104 (and optionally corresponding reference light source 106) and an operating light source (and optionally corresponding reference light source) of a second color are reduced until the two ratios become equal.

In some other embodiments, when the two ratios are different, the controller unit 116 may adjust the magnitudes of the driving current (to be fed to the light source 104 of first color and to the operating light source of second color) until the deviation of the ratio is minimized. For example, the deviation within three percent may be allowed. In one embodiment, deviation of the ratio may not affect the color of the lighting assemblies in case both light sources have exactly same deviation of light intensities. In such an embodiment, the deviation of the ratio may however affect the intensity of light sources.

In one embodiment, the apparatus 100 may optionally include a memory unit 118 (shown as dotted box in FIG. 1) that may be communicatively coupled to the controller unit 116 and may be configured to store the first and second reference intensity values. In another embodiment, the memory unit 118 may be configured to further store the ratio between the first and second intensity values, the ratio between the first and second reference intensity values, and a ratio between intensity values of different color light sources in the apparatus 100 (for example, a ratio between an intensity value of the operating light source 104 of first color and an intensity value of another operating light source of second color). Although shown separately in FIG. 1, the memory unit 118 may alternatively be integrated with the controller unit 116, in accordance with another embodiment. Alternatively or additionally, in another embodiment, the apparatus 100 may optionally include a user interface 120. The term ‘user interface’ as used herein refers to an interface between a user (or an operator) and one or more devices (such as the controller unit 116) that enables communication between the user and the devices. Examples of user interfaces include, but are not limited to, switches, potentiometers, buttons, dials, sliders, a mouse, a keyboard, a keypad, various types of game controllers (for example, joysticks), track balls, display screens, various types of graphical user interfaces (GUIs), touch screens, microphones and the like. In one embodiment, the user interface 120 may be operatively coupled to the controller unit 116 to receive the reference intensity values as input from the user of the apparatus 100.

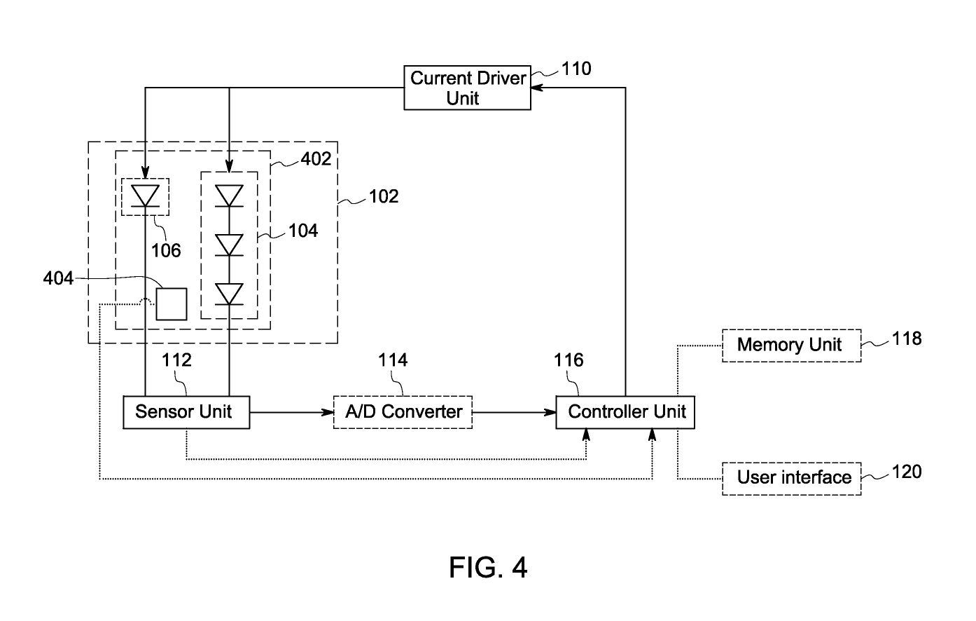

In some embodiments, the apparatus 100 may further include a temperature sensor unit 122 configured to monitor a temperature of each light source or a heat sink in which the light source is disposed. This temperature may cause change in the light intensity and hence change in the color of light emitted from a lighting assembly (such as 102). For example, as the temperature increases, the amount of light emitted by the light sources may reduce. In one embodiment, the driving current of each light source may be further adjusted according to the monitored temperature. Temperature dependence of the light intensities of the lighting assembly can be reduced or compensated using various approaches, as will be described later in conjunction with FIGS. 4-6. Although shown separately in FIG. 1, the temperature sensor unit 122 may alternatively be integrated with the lighting assembly 102, in accordance with another embodiment.

Components illustrated in the apparatus 100 are exemplary and may also include various other components (not shown in FIG. 1) such as, but not limited to, a buffer, a filtering module configured to discriminate or measure light intensity values of light emitted by light sources, and a separate duty cycle adjusting circuit configured to adjust duty cycles of light emitted from the light sources 104 and 106, instead of the being adjusted by the current driver unit 110. For example, the filtering module may be configured to measure light intensity of each different color light source in a mixed light (for example, received from a light mixing unit).

In various embodiments, either a single current driver may be used to drive both the light sources 104 and 106 or a current driver corresponding to each light source may be used to drive the respective light sources 104 and 106. FIG. 2 represents the lighting apparatus 100 including the current driver unit 110 corresponding to each light source 104, 106 in order to drive these light sources, in accordance with one embodiment. The light apparatus 100 in FIG. 2 illustrates two lighting assemblies emitting light of different wavelength such that each lighting assembly includes light sources 104 and 106 that emit light of same wavelength. As shown in FIG. 2, in some embodiments, each current driver unit 110 may include two current drivers 202 and 204 configured to drive respective light sources 104 and 106. In one embodiment, the current drivers 202 and 204 may be configured to drive the light source 104 and the corresponding light source 106, respectively, of same wavelength with driving current of same magnitude. Alternatively, in another embodiment, the current driver 204 may be configured to change the driving current of only light source 104, while the driving current of the corresponding light source 106 remains unchanged.

FIG. 3 represents the lighting apparatus 100 including a single current driver 302 that is used to drive both the light sources 104 and 106 of same wavelength, in accordance with another embodiment. The light apparatus 100 in FIG. 3 illustrates two lighting assemblies emitting light of different wavelength such that each lighting assembly includes light sources 104 and 106 that emit light of same wavelength. As shown in FIG. 3, in some embodiments, the current driver 302 may be configured to drive both light sources 104 and 106 of same wavelength with driving current of same magnitude. The apparatus 100 in FIG. 1 further includes a switch 304, such as a metal oxide semiconductor field-effect transistor (MOSFET), a bipolar junction transistor (BJT), or the like, in each lighting assembly and is positioned between the light source 104 and corresponding light source 106 of same wavelength. In various embodiments, the controller unit 116 may be configured to control the opening and closing of the switch 304. In one embodiment, when the switch 304 is in a closed position, the light source 106 is bypassed such that the sensor unit 112 may sense light emitted from only the light source 104 and hence may determine the first intensity value from the emitted light. In another embodiment, when the switch 304 is in an open position, the sensor unit 112 may sense light emitted from both light sources 104 and 106, and hence may determine an additive output of the first and second intensity values from the emitted light. In some embodiments, the first intensity value determined when is in the closed position is subtracted from the additive output when the switch 304 is in the open position in order to obtain the second intensity value corresponding to the light emitted from the light source 106. This process is then repeated for all other lighting assemblies in the apparatus 100. As described above in conjunction with various embodiments of FIG. 1, the sensor unit 112 may then send intensity values to the controller unit 116 for further processing.

The circuitry shown in FIG. 3 is exemplary and any other circuitry may be used herein while retaining the advantage of using a single current driver to drive both the light sources 104 and 106 of same wavelength.

Since a light intensity value of a light source is a function of a temperature of that light source, in addition to driving current and ON time of the light source, the temperature of the light source needs to be measured and considered when determining its corresponding light intensity value. FIGS. 4-6 describe different embodiments to eliminate or compensate for the influence of the temperature on the light intensity value. FIG. 4 illustrates the lighting assembly 102 (in the apparatus 100) including the light sources 104 and 106 disposed on a same heat sink 402, in accordance with one embodiment. As shown in FIG. 4, in some embodiments, the lighting assembly 102 may include a temperature sensor unit 404, also disposed on the heat sink 402 and configured to detect a temperature of the heat sink 402. FIG. 4 considers that the light source 104 is a blue-shifted YAG (BSY) operating LED and the corresponding light source 106 is a BSY reference LED. The temperature sensor unit 404 is operatively coupled to the controller unit 116 and is configured to provide the detected temperature to the controller unit 116. In some embodiments, since the light sources 104 and 106 are disposed on the same heat sink 402, the temperatures of these light sources may be approximately same and hence the controller unit 116 need not compensate for the temperature of the reference light source 106.

In some embodiments, intensity values for LEDs are computed using the following equations:

IV_{bsy}=K_{bsy}*f_{bsy}(I_{bsy},T_{bsy},ontime) eq. 1

IV_{bsyref}=K_{bsyref}*f_{bsyref}(I_{bsyref},T_{bsyref},ontime_{ref}) eq. 2

where,
IV_{bsy} is intensity value of BSY operating LED
IV_{bsyref} is intensity value of BSY reference LED
K_{bsy} and K_{bsyref} are coefficients of BSY operating LED and BSY reference LED, respectively
f_{bsy} and f_{bsyref} are transfer functions of BSY operating LED and BSY reference LED, respectively
I_{bsy} and I_{bsyref} are driving currents of BSY operating LED and BSY reference LED, respectively
T_{bsy} and T_{bsyref} are temperatures of BSY operating LED and BSY reference LED, respectively
Ontime _{and} ontime_{ref} are durations for which BSY operating LED and BSY reference LED, respectively, are turned ON

The ratio of the coefficients K_{bsy} and K_{bsyref} may depend on the number of LEDs and their optical configuration within a troffer with respect to the sensor unit 112. Transfer functions fbsy and fbsyref are based on three parameters, that is, current, temperature, and ON time as LEDs age over time. The BSY reference LED is operated at a low duty cycle so ontime_{ref}<<ontime.

The sensor responses of intensity values measured for BSY operating LED (Measured_{bsy}) and BSY reference LED (Measured_{bsyref}) are computed using the below equations.

Measured_{bsy}=IVsensor(IV_{bsy}) eq. 3

Measured_{bsyref}=IVsensor(IV_{bsyref}) eq. 4

where, IVsensor is intensity value measured at the sensor unit 112.

If the IVsensor is linear with respect to measured intensity value, the ratio between the intensity values is calculated from Measured_{bsy} and Measured_{bsyref} using the below equation.

IV_{bsy}/IV_{bsyref}=Measured_{bsy}/Measured_{bsy} eq. 5

I_{bsy} is equal to I_{bsyref}, and T_{bsy} may be equal to T_{bsyref} as the BSY reference LED is on the same heat sink 402 as BSY operating LED, for example, as considered in FIG. 4. Therefore, the ratio IV_{bsy}/IV_{bsyref} obtained from Measured_{bsy}/Measured_{bsy} may vary only with ON time of the BSY operating LED and ON time of the BSY reference LED, and its change gives an estimate of the aging-related IV_{bsy} change. Despite the low duty cycle of the reference LED, its junction temperature is approximately same as the temperature of the heat sink 402 on which both the reference and operating LEDs are disposed. Due to high junction temperature of the reference LED, the reference LED may also be prone to aging; however, the aging of the reference LED will be significantly slower than the aging of its corresponding operating LEDs of same color.

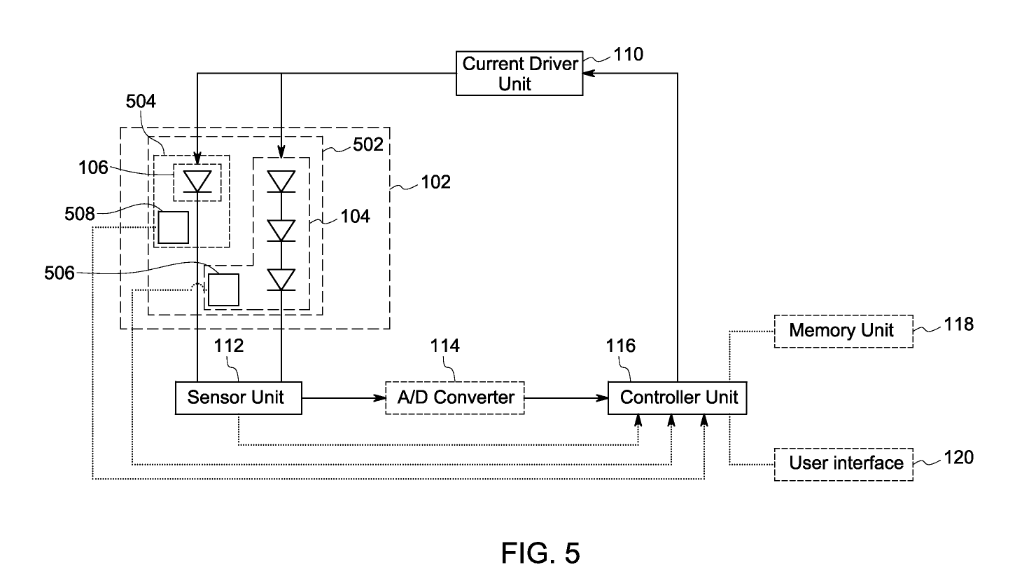

FIG. 5 illustrates the lighting assembly 102 (in the apparatus 100) including the light source 104 disposed on a first heat sink 502 and the light source 106 disposed on a second heat sink 504, in accordance with another embodiment. As shown in FIG. 5, in some embodiments, the lighting assembly 102 may include a first temperature sensor unit 506, disposed on the first heat sink 502 and configured to detect a temperature of the light source 104. Also, as shown in FIG. 5, in some other embodiments, the lighting assembly 102 may include a second temperature sensor unit 508, disposed on the second heat sink 504 and configured to detect a temperature of the light source 106. Such a configuration of the lighting assembly 102 may minimize the aging effects of the reference light source 106 as its heat sink 504 may be at a lower temperature as compared to the temperature of the operating light source 104 due to lower duty cycle of the light source 106 as compared that of the light source 104. The second temperature sensor unit 508 may be disposed in the reference light source's heat sink 504 to compensate for the light intensity difference due to the difference in temperatures of the two heat sinks 502 and 504. The controller unit 116 is configured to be operatively coupled to the temperature sensor units 506 and 508 to receive the temperature values of the light sources 104 and 106 from the respective temperature sensor units 506 and 508, and may compensate for the light intensity difference due to different temperatures of the two heat sinks 502 and 504.

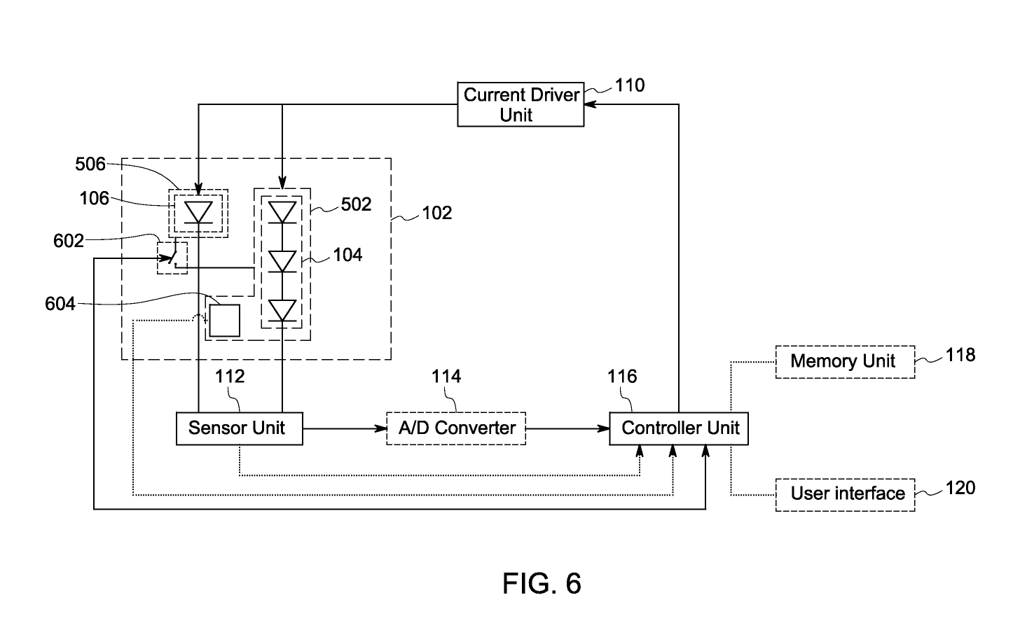

FIG. 6 illustrates the lighting assembly 102 (in the apparatus 100) including a thermal relay 602 disposed between the light sources 104 and 106 and configured to thermally couple or decouple the light source 106 disposed on the second heat sink 504 from the light source 104 disposed on the first heat sink 502, in accordance with yet another embodiment. In various embodiments, the controller unit 116 may be configured to send a control signal to the thermal relay 602 to thermally couple or decouple the light source 106 from the light source 104. In one embodiment, prior to switching ON the light source 106, that is, when the intensity value of the light source 106 is to be determined, the controller unit 116 is configured to send the control signal to the thermal relay 602 to couple the light source 106 to the light source 104. In one exemplary embodiment, a time gap is provided between a time instance when the light source 106 is coupled to the light source 104 and a time instance when the sensor unit 112 senses the light emitted from the light sources 104 and 106. This time gap is introduced to ensure that the temperature of the reference light source's heat sink 504 reaches close to the temperature of the operating light source's heat sink 502 before sensing the emitted light, in order to eliminate the dependency of intensity values on temperature difference of the two heat sinks 502 and 504.

As shown in FIG. 6, in some embodiments, the lighting assembly 102 may include a temperature sensor unit 604 that is disposed on the second heat sink 504 and configured to detect temperature of the light source 106's heat sink 504. In another embodiment, after switching OFF the light source 106, that is, once the intensity value of the light source 106 is determined and the magnitudes of driving current of the light sources 104 and 106 are adjusted (if required), the controller unit 116 may be configured to send the control signal to the thermal relay 602 to decouple the light source 106 from the light source 104. In such embodiments, the controller unit 116 may include a timer to record ON time and OFF time of the reference light source 106 so that the controller unit 116 may couple the light source 106 to the light source 104 prior to the ON time of the reference light source 106 and decouple the light source 106 from the light source after the OFF time of the light source 106.

In various embodiments, the operating light sources may be approximately equidistant (for example, 30 to 50 millimeter) from the sensor unit 112. Similarly, in some other embodiments, various reference light sources corresponding to respective operating light sources may be disposed at approximately same distance (for example, 0.5 to 1 millimeter) from the sensor unit 112. In one such embodiment, the sensor unit 112 is disposed on a same heat sink on which the operating and reference light sources are disposed. Disposing the sensor unit 112 closer to the reference light source than to any of the operating light sources may increase the comparison accuracy of measurement of the response (second intensity value) of the reference light source (such as 106) and the measurement of the response (intensity values) of all operating light sources (such as 104) of same color as the reference light source. In other embodiments, the operating light sources may not be equidistant from the sensor unit 112.

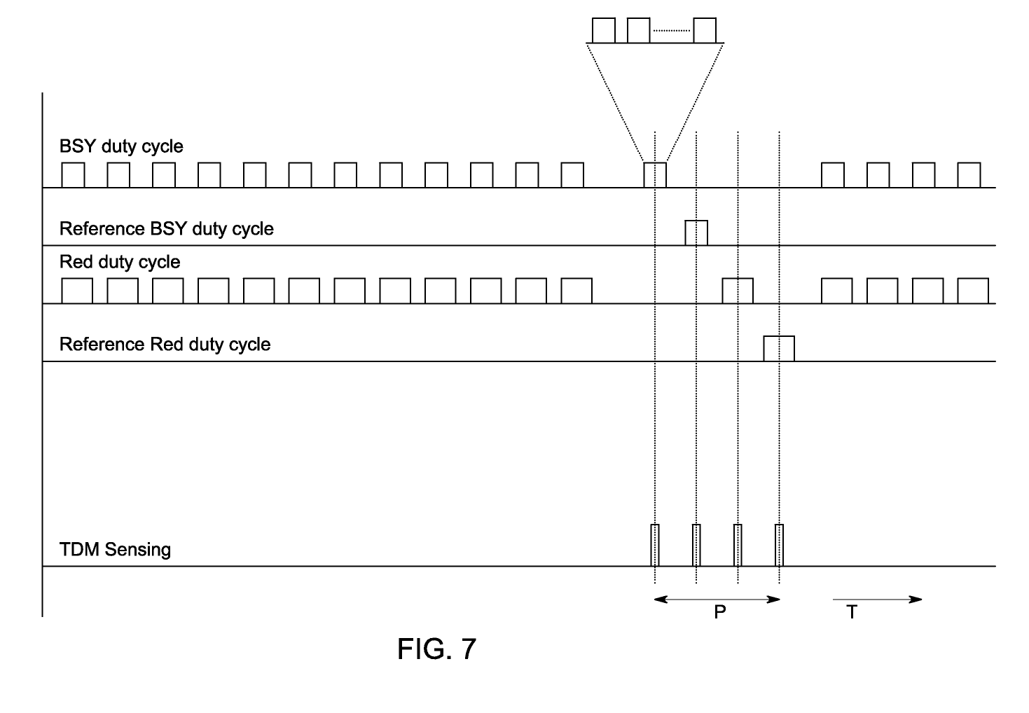

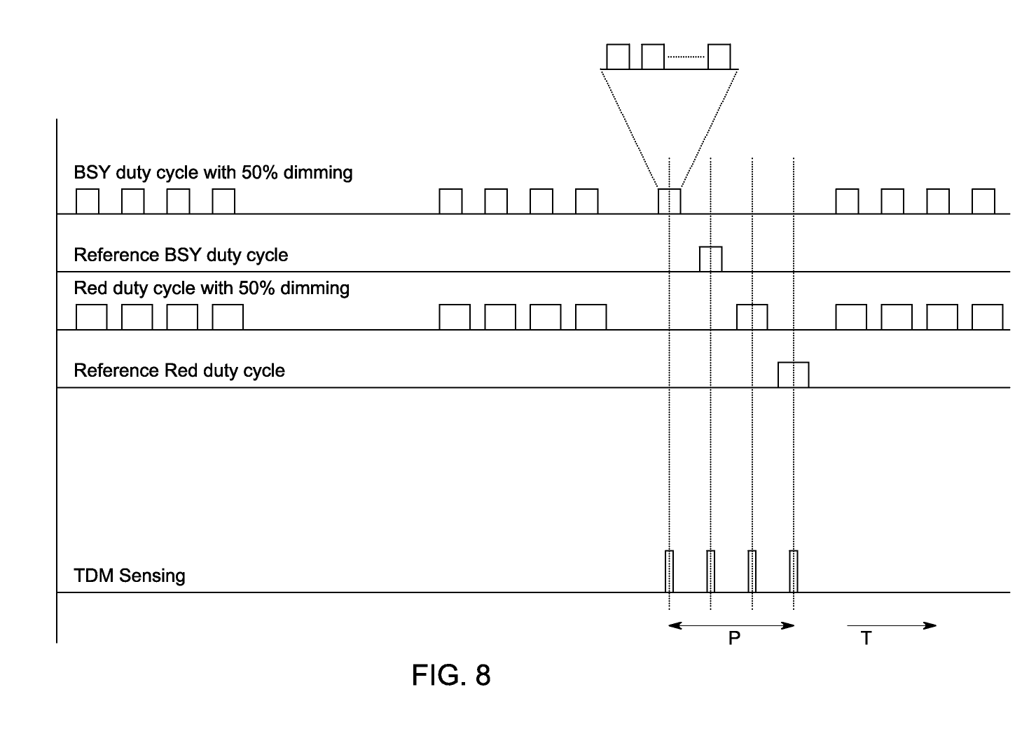

Various techniques for sensing the light emitted from the light sources are known in the art. One such technique uses time-division multiplexing (TDM). FIGS. 7 and 8 illustrate two different approaches to sense light emitted by light sources in a time-sharing manner, that is, TDM. FIG. 7 illustrates schematically timing charts of duty cycles of respective light sources in a BSY+R lighting assembly for sensing light emitted by light sources using TDM, in accordance with one embodiment. The BSY+R lighting assembly includes light sources such as a BSY operating LED, a BSY reference LED corresponding to the BSY operating LED of same wavelength (BSY), a red operating LED, and a red reference LED corresponding to the red operating LED of same wavelength (red). FIG. 7 shows a continuous duty cycle of each LED, that is, without any dimming of LEDs. In some embodiments, the sensor unit 112 may sense the ON pulse of only one LED (for example, red operating LED) at a given time. For example, during a first duty cycle (“BSY duty cycle”), the BSY operating LED 102 is driven to emit the BSY light that is fed to the sensor unit 112. Upon receiving the BSY light, the sensor unit 112 senses the BSY light to obtain corresponding intensity value. However, during a second duty cycle (“Reference BSY duty cycle”), the BSY reference LED is driven to emit the BSY light that is fed to the sensor unit 112. In some embodiments, the current driver unit 110 is configured to provide driving currents to the BSY reference LED to turn ON the BSY reference LED prior to determination of the intensity value of the BSY reference LED. In one exemplary embodiment, the controller unit 116 or the current driver unit 110 may store the duty cycle of the BSY reference LED and may turn ON this LED few seconds (or milliseconds) prior to initiating the process for determining the intensity value of the LED.

As shown in FIG. 7, the frequency of ON time or positive pulses of the BSY reference LED (which denotes the second duty cycle of the BSY reference LED) is less than the frequency of the positive pulses of the corresponding BSY operating LED (which denotes the first duty cycle of the BSY operating LED). The sensor unit 112 senses the BSY light to obtain corresponding intensity value. With repeated operation, the sensor unit 112 obtains the intensity values corresponding to the red operating LED and the red reference LED, respectively, and sends these obtained intensity values to the controlling unit 116 either directly or via the A/D converter 114. In one embodiment, the user may define the period (sensing period ‘P’ as shown in FIGS. 7 and 8), for example, every month after which the sensing process may be repeated. Although a single positive pulse is shown in FIG. 7 during when the sensing is performed for each LED; however, each such positive pulse may include a plurality of positive pulses since the duration of sensing for each LED may be spanned across multiple positive pulses. Also, even though not shown in FIG. 7, the sensor unit 112 may determine an ambient value from the light emitted from the light sources and may use it as a reference against the intensity values of various light sources. In one embodiment, if the ambient value is greater than zero, then this value is subtracted from the intensity values of all light sources for offset removal. In one exemplary embodiment, in order to make the sensing process near real-time, the sensing period ‘P’ is kept small, for example, 10 to 50 milliseconds (ms).

FIG. 8 illustrates schematically timing charts of duty cycles of respective light sources in the BSY+R lighting assembly for sensing light emitted by light sources using TDM, in accordance with another embodiment. FIG. 8 considers that the duty cycle of each operating LED (that is, BSY operating LED and red operating LED) has fifty percent dimming, which means that if 200 Hz (period is 5 ms) dimming is applied to each operating LED the operating LED will be switched ON for 2.5 ms, and OFF for 2.5 ms as well. The duty cycles of reference LEDs (that is, BSY reference LED and red reference LED) are same as those shown in FIG. 7. Various embodiments described above in conjunction with FIG. 7 may be equally applied here.

Fifty percent or no dimming are two exemplary embodiments described above; however, any percentage of dimming can be applied to the operating LEDs without deviating from the scope of the invention.

Alternatively, in some other embodiments, the sensor unit 112 may be configured to sense the light emitted from two or more lighting assemblies of different wavelengths at the same time. In one exemplary embodiment, if the apparatus 100 includes red, green and blue (RGB) lighting assemblies (with each assembly including one or more operating light sources and corresponding reference light source of same wavelength), the sensor unit 112 senses lights from two different colored light sources at the same time, for example, red and green light sources at same time, or blue and green light sources at same time, or red and blue light sources at same time.

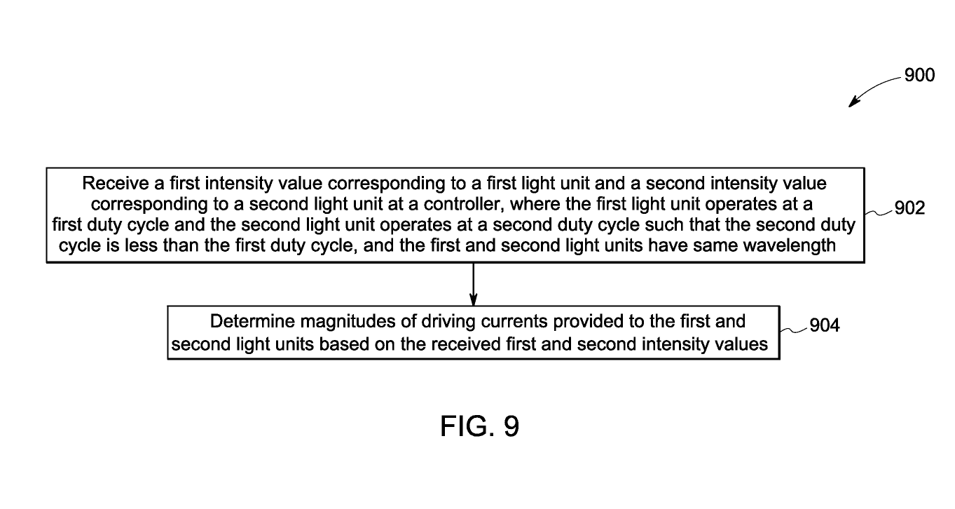

In one embodiment, a method for accurately determining intensity output of a light source is provided. FIG. 9 is a flowchart depicting a method 900 for maintaining light intensities of operating light sources, in accordance with one embodiment. At step 902, a first intensity value corresponding to a first light unit (“operating light source”) and a second intensity value corresponding to a second light unit (“reference light source”) may be received. In one exemplary embodiment, a controller unit (such as 116) receives these intensity values from a sensor unit (such as 112) either directly or via an A/D converter (such as 114). Moreover, in some embodiments, the operating light source operates at a first duty cycle and the reference light source operates at a second duty cycle such that the second duty cycle is less than the first duty cycle, and these light sources emit light having a same wavelength. In one embodiment, the operating and reference light sources may be driven with driving current of same magnitude. Alternatively, in another embodiment, the driving current of only operating light source may be varied, while the driving current of the corresponding reference light source may remain unchanged.

In one embodiment, prior to determining the intensity values of the operating and reference light sources, the controller unit or the current driver unit may be configured to switch ON the reference light source so that the reference light source emits light that the sensor unit uses to determine corresponding intensity value.

At step 904, magnitudes of driving current may be determined and provided to the operating and reference light sources based on the received first and second intensity values. In some embodiments, in order to determine magnitudes of the driving current provided, the controller unit compares a ratio between the first and second intensity values with a ratio between first and second reference intensity values. The first and second reference intensity values are the intensity values of the respective operating and reference light sources and are determined for future reference. In one embodiment, when the two ratios are equal, the magnitudes of the driving current remain unchanged; however, when these two ratios are different, the controller unit may change the magnitudes (either of the operating light source alone or of both the operating and reference light sources) of the driving current until the two ratios become equal. In some other embodiments, when the difference in the two ratios signifies that the operating light source has deteriorated (that is, when the two ratios are different), the controller unit may adjust the magnitudes of the driving current until the deviation of the ratio between the first and second intensity values from the ratio between the first and second reference intensity values is minimized.

The above-mentioned operation of receiving intensity values and determining magnitudes of driving current based on these values may be repeated continuously until the ratio between the first and second intensity values and the ratio between first and second reference intensity values become equal or the deviation is minimized.

Various embodiments described above in conjunction with FIGS. 1-8 above may be equally applied to the method 900 for maintaining light intensities of operating light sources by accurately determining intensity output of these light sources, in addition to providing color stability for the color mixing lighting assemblies.

The systems and methods in accordance with embodiments of the invention may accurately determine intensity output of light sources by providing a reference light source that may operate at a lower duty cycle than one or more operating light sources corresponding to that reference light source, where these light sources emit light of same wavelength. The reference light source is used as a reliable reference to check for the light intensity deterioration of the corresponding operating light source of same wavelength. The embodiments of the invention differentiate between deterioration of the light source and deterioration of a sensing chain using the systems and methods described herein.

The skilled artisan will recognize the interchangeability of various features from different embodiments. Similarly, the various method steps and features described, as well as other known equivalents for each such methods and features, can be mixed and matched by one of ordinary skill in this art to construct additional assemblies and techniques in accordance with principles of this invention. It is, therefore, to be understood that the appended claims are intended to cover all such modifications and changes as fall within the true spirit of the invention.

1. A lighting assembly comprising:
a first light unit configured to operate at a first duty cycle; and
a second light unit configured to operate at a second duty cycle, wherein the second duty cycle is less than the first duty cycle, and the first and second light units emit light having a same wavelength.

2. The lighting assembly of claim 1, wherein the first and second light units are configured to be driven with driving current of same magnitude.

3. The lighting assembly of claim 1, wherein the first and second light units are electrically coupled to a current driver unit and the current driver unit is configured to provide driving currents to the first and second light units.

4. The lighting assembly of claim 1, wherein the first and second light units are optically coupled to a sensor unit and the sensor unit is configured to sense light emitted from the first light unit and light emitted from the second light unit so as to determine corresponding first and second intensity values.

5. The lighting assembly of claim 4, wherein the first and second light units are communicatively coupled to a controller unit, and the controller unit is configured to receive the first and second intensity values from the sensor unit and determine magnitudes of a driving current provided by a current driver unit to the first and second light units based on the received first and second intensity values.

6. The lighting assembly of claim 5, wherein the controller unit is communicatively coupled to a memory unit and the memory unit is configured to store a first reference intensity value of the first light unit and a second reference intensity value of the second light unit.

7. The lighting assembly of claim 4, wherein the controller unit is further configured to compare a ratio between the first and second intensity values with a ratio between first and second reference intensity values to determine magnitudes of a driving current provided by the current driver unit to the first and second light units.

8. The lighting assembly of claim 1, wherein the second light unit is configured to be switched ON when a second intensity value of the second light unit is to be determined.

9. The lighting assembly of claim 1, further comprising:
a heat sink, wherein the first light unit and the second light are disposed on the heat sink; and
a temperature sensor unit disposed on the heat sink and configured to detect a temperature of the heat sink.

10. The lighting assembly of claim 1, further comprising first and second heat sinks, wherein the first light unit is disposed on the first heat sink and the second light unit is disposed on the second heat sink.

11. The lighting assembly of claim 10, further comprising a thermal relay disposed between the first and second light units and configured to thermally couple or decouple the second light unit from the first light unit.

12. The lighting assembly of claim 10, further comprising a temperature sensor unit disposed on the second heat sink and configured to detect temperature of the second heat sink.

13. A lighting apparatus comprising:
a lighting assembly comprising:
a first light unit configured to operate at a first duty cycle, and
a second light unit configured to operate at a second duty cycle, wherein the second duty cycle is less than the first duty cycle, and the first and second light units emit light having a same wavelength;
a current driver unit electrically coupled to the first and second light units and configured to provide driving currents to the first and second light units;
a sensor unit optically coupled to the first and second light units and configured to sense light emitted from the first light unit and light emitted from the second light unit so as to determine corresponding first and second intensity values; and
a controller unit communicatively coupled to the sensor unit and the current driver unit, and configured to receive the first and second intensity values from the sensor unit and determine magnitudes of the driving current provided by the current driver unit to the first and second light units based on the received first and second intensity values.

14. The lighting apparatus of claim 13, wherein the first and second light units are configured to be driven with the driving current of same magnitude.

15. The lighting apparatus of claim 13, further comprising a memory unit configured to store a first reference intensity value of the first light unit and a second reference intensity value of the second light unit.

16. The lighting apparatus of claim 13, wherein the controller unit is further configured to compare a ratio between the first and second intensity values with a ratio between first and second reference intensity values to determine the magnitudes of the driving current provided by the current driver unit to the first and second light units.

17. The lighting apparatus of claim 13, wherein the second light unit is configured to be switched ON when the second intensity value of the second light unit is to be determined.

18. The lighting apparatus of claim 13, wherein the lighting assembly further comprises:
a heat sink, wherein the first light unit and the second light are disposed on the heat sink; and
a temperature sensor unit disposed on the heat sink and configured to detect a temperature of the heat sink.

19. The lighting apparatus of claim 13, wherein the lighting assembly further comprises first and second heat sinks, wherein the first light unit is disposed on the first heat sink and the second light unit is disposed on the second heat sink.

20. The lighting apparatus of claim 19, wherein the lighting assembly further comprises a thermal relay disposed between the first and second light units and configured to thermally couple or decouple the second light unit from the first light unit.

21. The lighting apparatus of claim 19, wherein the lighting assembly further comprises a temperature sensor unit disposed on the second heat sink and configured to detect temperature of the second heat sink.

22. A method comprising:
receiving a first intensity value corresponding to a first light unit and a second intensity value corresponding to a second light unit at a controller unit, wherein the first light unit operates at a first duty cycle and the second light unit operates at a second duty cycle such that the second duty cycle is less than the first duty cycle, and the first and second light units emit light having a same wavelength; and
determining by the controller unit, magnitudes of driving current provided to the first and second light units based on the received first and second intensity values.

23. The method of claim 22, further comprising driving the first and second light units with the driving current of same magnitude.

24. The method of claim 22, wherein determining magnitudes of the driving current comprises:
determining a first reference intensity value of the first light unit and a second reference intensity value of the second light unit; and
comparing a ratio between the first and second reference intensity values with a ratio between the first and second intensity values to determine the magnitudes of the driving current provided to the first and second light units.

25. The method of claim 22, further comprising switching ON the second light unit prior to determining the first and second intensity values.
